(19) United States
(12) Patent Application Publication
(10) Pub. No.: US 2026/0322732 A1
(43) Pub. Date: Oct. 15, 2026

(54) APPARATUS AND METHOD FOR VIRTUAL NETWORK SERVICES USING A SINGLE-AREA UNDERLAY NETWORK

(71) Applicant: Extreme Networks, Inc., San Jose, CA (US)

(72) Inventors: Constantin Barcaru, Brasov (RO); Roger Lapuh, Uesslingen (CH)

(73) Assignee: Extreme Networks, Inc., San Jose, CA (US)

(21) Appl. No.: 19/174,333

(22) Filed: Apr. 9, 2025

(51) Int. Cl. H04L 45/12; H04L 45/16

(52) U.S. Cl. CPC H04L 45/12; H04L 45/16; H04L 2212/00

(57) ABSTRACT

Provided herein are systems and methods for facilitating communication of overlay unicast or multicast packets over an underlay single-area network. A single-area network can have an edge node that receives an overlay packet from a host device, determines whether a unicast or a multicast service is to be provided to the host device, encapsulates the overlay packet into an underlay packet by adding an encapsulation header, and forwards the encapsulated packet to a receiving edge node based on a shortest path. The receiving edge node can de-encapsulate the underlay packet and transmit the overlay packet to a host device.

### CROSS-REFERENCE TO RELATED APPLICATIONS

This application is related to U.S. Patent Application No. ________ titled Shortest Path Bridging and Routing (SPBX) in Multi-Area filed herewith (Attorney Docket No. 4264.7500000) and U.S. Patent Application No. ________ titled Overlay Internet Protocol Multicast Streams Over a Multi-Area Virtual Network filed herewith (Attorney Docket No. 4264.7510000), which are herein incorporated by reference in their entireties.

### FIELD

The described aspects generally relate to providing networking services using an underlay network. The underlay network can be a single-area network or a multi-area network.

### BACKGROUND

Existing Shortest Path Bridging Medium Access Control (MAC) mode (SPBM) only allows to build a flat network in a single area. This puts a practical deployment limitation on the number of nodes that an SPB network can have. Many contemporary multi-area network fabrics are using Ethernet Virtual Private Network (EVPN) technologies based on Multiprotocol Border Gateway Protocol (MP-BGP) and Protocol Independent Multicast (PIM) protocol, which makes multi-area network fabric configurations cumbersome to implement and computationally expensive to maintain.

As a result, systems, methods, and/or computer programs are needed to implement an improved single-area network fabric that enables highly scalable and easy-to-deploy multi-area network fabrics for SPB network.

### SUMMARY

Provided herein are system, method, and/or computer program aspects, and/or combinations and sub-combinations thereof, which facilitate communication of overlay unicast or multicast data over an underlay network in accordance with Shortest Path Bridging and Routing (SPBX) using Internet Protocol (IP)-based encapsulation of data traffic.

Some aspects of this disclosure relate to systems and methods for facilitating the communication of overlay unicast or multicast data over an underlay network including one or more network nodes. These elements of the SPBX network may be implemented in conjunction with an Internet Protocol (IP)-based data plane and a single control plane for bridging and routing overlay IP unicast or multicast packets. In some aspects, the data plane may be an IPv4 or IPv6 data plane. The data plane may be programmed such that every overlay packet can be forwarded to reach one or more end nodes in the shortest network path and avoid looping. In some aspects, the control plane is a single Intermediate System to Intermediate System (ISIS or IS-IS) routing protocol. In some aspects, the underlay network is a single-area network. In some aspects, the underlay network is a multi-area network. Some aspects of a single-area SPBX underlay network is discussed herein.

Some aspects of this disclosure relate to a computer-implemented method. The method includes receiving an overlay Ethernet frame from a first host node by a first network node. The first network node determines a transmission scheme for the overlay Ethernet frame, and the transmission scheme is one of a unicast scheme, or a broadcast, unknown unicast or a multicast (BUM) scheme. The first network node determines a second network node for receiving the overlay Ethernet frame based on the service and a shortest path from the first network node to the second network node. The method further includes encapsulating the Ethernet frame into an encapsulated packet by adding an encapsulation header, and transmitting the encapsulated packet to the second network node based on the shortest path. The encapsulation header may include information of the first network node, a service identifier (ID), and an ID of the shortest path. In some aspects, the encapsulation header also includes a first system ID of the first network node, a first system IP address of the first network node, a multicast tree ID and an IP Multicast group address.

In some aspects, the first network node includes an Intermediate System to Intermediate System (ISIS) link state database (LSDB) associated with the underlay network.

In some aspects, the method further includes identifying a shortest path tree based on a nickname of the first network node and the service ID, and determining the ID of the shortest path using a hashing algorithm. The nickname corresponds to a predefined number of least significant bits of an IP address of the first network node.

In some aspects, the ISIS LSDB includes system IP addresses of underlay network nodes, and the method further includes identifying a shortest path tree based on a system IP address of the first network node and a group IP address and determining the ID of the shortest path using a hashing algorithm.

In some aspects, the method includes receiving a second overlay Ethernet frame from the first host node by the first network node. The first network node determines a second shortest path from the first network node to the second network node, and the second shortest path is different from the shortest path. The method further includes encapsulating the second overlay Ethernet frame into a second encapsulated packet by adding a second encapsulation header, and transmitting the second encapsulated packet to the second network node based on the second shortest path. The second encapsulation header includes the service ID and a second ID of the second shortest path.

Some aspects of this disclosure relate to one or more tangible computer-readable devices having instructions stored thereon that, when executed by one or more network nodes in a network area, causes the one or more network nodes to perform operations of receiving an overlay Ethernet frame from a first host node and determining a transmission scheme for the overlay Ethernet frame, and the transmission scheme is one of a unicast scheme, or a broadcast, unknown unicast or a multicast (BUM) scheme. The operations further include determining a second network node for receiving the overlay Ethernet frame, and determining a shortest path from the first network node to the second network node. The operations further include encapsulating the Ethernet frame into an encapsulated packet by adding an encapsulation header, and transmitting the encapsulated packet to the second network node based on the shortest path. The encapsulation header may include information of the first network node, a service identifier (ID), and an ID of the shortest path. In some aspects, the encapsulation header also includes a first system ID of the first network node, a first system IP address of the first network node, a multicast tree ID and an IP Multicast group address.

Some aspects of this disclosure relate to a system. The system includes a memory and a first backbone edge bridge (BEB) coupled to the memory. The first BEB can be configured to receive an overlay Ethernet frame from a first host node, and determine a transmission scheme for the overlay Ethernet frame. The transmission scheme is one of a unicast scheme, or a broadcast, unknown unicast or a multicast (BUM) scheme. The first BEB is further configured to determine a second BEB for receiving the overlay Ethernet frame based on the service, determine a shortest path from the first BEB to the second BEB and encapsulate the first Ethernet frame into an encapsulated packet by adding an encapsulation header. The encapsulation header may include information of the first network node, a service identifier (ID), and an ID of the shortest path. In some aspects, the encapsulation header includes a first system ID of the first network node, a first system IP address of the first network node, a second system ID of the second network node, a second system IP address of the second network node. In some aspects, the encapsulation header includes a first system ID of the first network node, a first system IP address of the first network node, a multicast tree ID and an IP Multicast group address. The system also includes a backbone core bridge (BCB) coupled to the memory and configured to forward the IP packet according to the shortest path from the first BEB to the second BEB.

This summary is provided for purposes of illustrating some aspects of the disclosure to provide an understanding of the subject matter described herein. Accordingly, the above-described features are examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates a block diagram of a networking system with a single-area underlay network, according to some aspect of the disclosure.

FIG. 2A illustrates a block diagram for a network environment including a single-area underlay network for providing network services to host devices using unicast, according to some aspects of the disclosure.

FIG. 2B illustrates a block diagram for a network environment including a single-area underlay network for providing network services to host devices using unicast, according to some aspects of the disclosure.

FIG. 3 is a flow chart illustrating an example method performed by an ingress node for network services using unicast according to some aspects of the disclosure.

FIG. 4 is a flow chart illustrating an example method performed by a core node for forwarding underlay network packets, according to some aspects of the disclosure.

FIG. 5 is a flow chart illustrating an example method performed by an edge node for forwarding underlay network packets, according to some aspects of the disclosure.

FIG. 6A illustrates a block diagram for network environment including a single-area underlay network for providing network services to host devices using broadcast, unknown unicast or multicast (BUM), according to some aspects of the disclosure.

FIG. 6B illustrates a block diagram for network environment including a single-area underlay network for providing network services to host devices using BUM, according to some aspects of the disclosure.

FIG. 7 is a flow chart illustrating an example method performed by an ingress node for network services using BUM according to some aspects of the disclosure.

FIG. 8 is a flow chart illustrating an example method performed by a core node for forwarding underlay network packets, according to some aspects of the disclosure.

FIG. 9 illustrates a block diagram of a general-purpose computer that can be used to perform various aspects of the present disclosure, according to some aspects of the disclosure.

In the drawings, like reference numbers generally indicate identical or similar elements. Additionally, the left-most digit(s) of a reference number generally identifies the drawing in which the reference number first appears.

### DETAILED DESCRIPTION

Provided herein are system, method, and/or computer program product aspects and/or combinations and sub-combinations thereof, which facilitate transmitting overlay unicast or multicast packets over a single-area underlay network.

A network topology may be segmented into underlay and overlay networks. An underlay network may refer to the physical network infrastructure, such as Ethernet switches, nodes, routers, or a combination thereof, that forwards data packets from a host device to a receiving device. The overlay network may refer to a virtual network interconnecting end devices among the network topology.

Some aspects of this disclosure make use of an IP-based data plane and Intermediate System to Intermediate System (ISIS or IS-IS) control plane to implement shortest path bridging and routing using IP-based encapsulation of data traffic (SPBX) over a single-area network. The combination of an IP-based data plane and ISIS control plane enables a highly scalable multi-tenant, multi-area IP multicast solution supported by modern ASIC technologies and modernizes legacy solutions based on the IEEE 802.1ah networking standard.

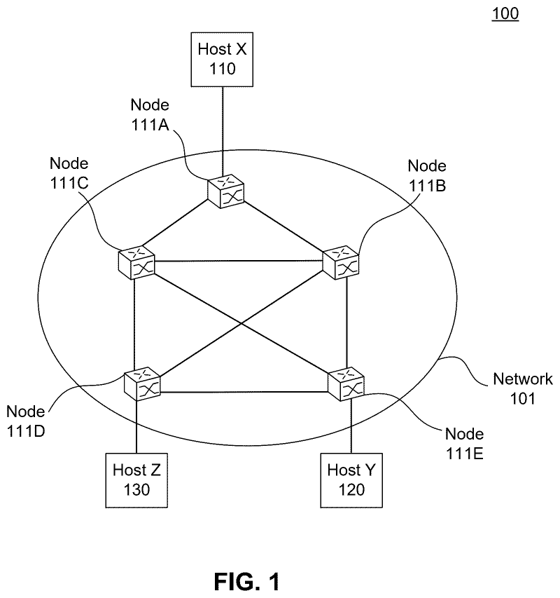

FIG. 1 illustrates a block diagram of a networking system 100 according to some aspects of the disclosure. The networking system 100 may have an underlay network 101, which includes one or more nodes 111A to 111E. Network 101 can include any number of nodes 111 and the number of nodes 111 depicted in FIG. 1 is exemplary. In some aspects, the underlay network 101 can provide one or more services to an overlay network. As a non-limiting example, such services can include transmitting data through network 101. In some examples, a virtual network may be created on top of network 101 for each service. As a non-limiting example, the virtual network can be a Layer 2 (L2) virtual network, or a Layer 3 (L3) virtual network. Each virtual network can be identified by a virtual network identifier (VNI). The VNI can be a string of letters and/or numbers.

In some aspects, network 101 is a single area network and each node of the network belongs to the same IP subnet. In some aspects, network 101 is a provider backbone bridged network (PBBN). Each node of network 101 can be identified by a unique system IP address, and/or a unique system ID. As a non-limiting example, the unique system IP of a node can be a Backbone IP (BIP) address of the node, and the unique system ID of a node can be a Backbone Medium Access Control (BMAC) address of the node. In some aspects, network 101 is a multi-area network and nodes of the network belongs to more than one IP subnets. The current disclosure is focused on a single-area network.

In some aspects, network 101 can be accessed by host X 110, host Y 120, and host Z 130. This can include network 101 providing network services to a host, a host requesting access to a service in network 101, and sending or receiving data from a host to network 101. The host X 110, host Y 120 and host Z 130 can belong to the same overlay network for accessing the services provided by network 101. Each host has an IP address and a MAC address in the overlay network. It is to be appreciated that the number of hosts depicted in FIG. 1 is exemplary.

In some aspects, a node of network 101 can connect to a host to provide network services to the host, such node is generally referred to as an edge node. A node of network 101 that only connects to other nodes of network 101 is generally referred to as a core node. As a non-limiting example, FIG. 1 illustrates that nodes 111A, 111D and 111E are edge nodes and nodes 111C and 111B are core nodes. While the various figures in this disclosure illustrate some exemplary network system 100, aspects of this disclosure are not limited to these examples, and network system 100 can include other topologies. In some examples, an edge node supports Backbone Edge Bridge (BEB) functionality and includes a user-network interface (UNI) to communicate with a host. Throughout the disclosure, such edge node may also be referred to as a BEB. In some examples, a core node supports Backbone Core Bridge (BCB) functionality and includes a network-to-network interface (NNI) to communicate with other nodes. Throughout the disclosure, such core node may also be referred to as a BCB.

In some aspects, network 101 includes a control plane, which is a single Intermediate System to Intermediate System (ISIS or IS-IS) routing protocol. The ISIS control plane may forward unicast or multicast overlay traffic over network 101 using shortest path bridging and routing. In some aspects, network 101 includes an ISIS link-state database (LSDB) instance that includes the identification, topology, services, and the like of every node in the network. The LSDB can be synchronized among all the nodes in the network, which allows every node to have the same view of the network and compute shortest-path trees consistently for implementing shortest path bridging and routing. In some aspects, the ISIS protocol uses a Type-Length-Value (TLV) encoding scheme to update the LSDB. In some aspects, the TLV data may include overlay IP addresses corresponding to host devices (e.g., host X 110, host Y 120, and/or host Z 130), an overlay IP multicast group address, and/or the BIPs of the underlay network nodes.

In some aspects, a node as discussed in this disclosure can include a fabric node and/or a network node such as, but not limited to, a connection point inside and/or at the boundary of a network that can receive, transmit, create, and/or store data and/or other information. Some non-limiting examples of a node can include computers, routers, gateways, modems, printers, scanners, TVs, smart phones, Internet of Things (IoT) devices, bridges, switches, and the like. In some aspects, a host as discussed in this disclosure can include a personal computer (PC), a server, connected devices, TVs, smart phones.

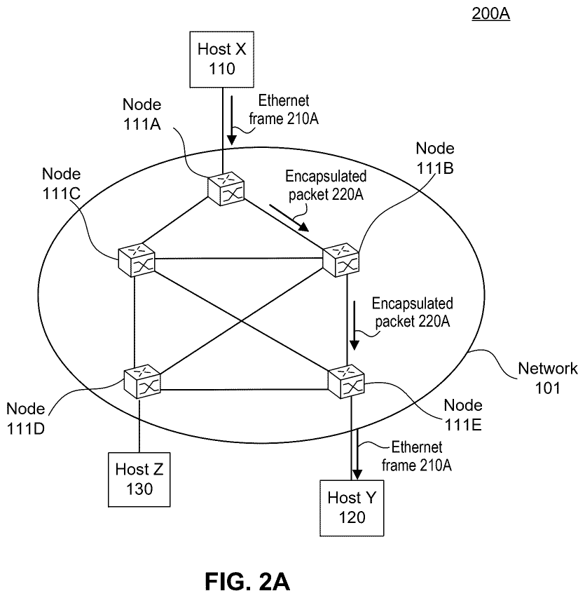

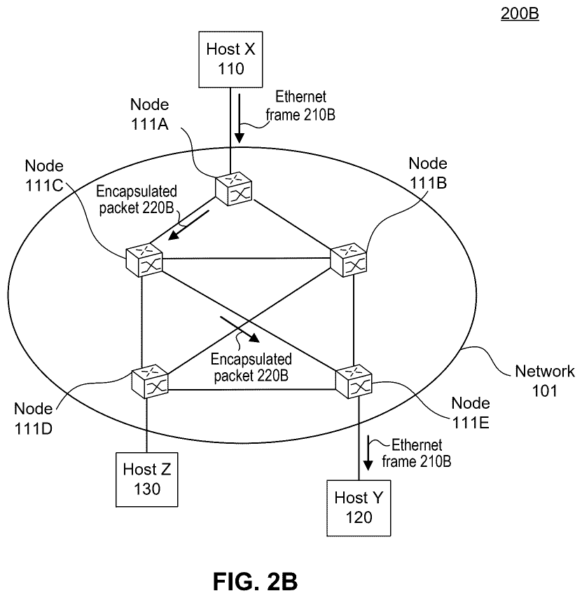

FIG. 2A illustrates a block diagram for a networking environment 200A including a single-area underlay network 101 for providing network services to host devices using unicast, according to some aspects. In some aspects, host X 110 accesses underlay network 101 for network services using unicast to send data to host Y 120. Data can be included in an overlay Ethernet frame 210A. The header of Ethernet frame 210A includes the MAC addresses of the source (host X 110), and the MAC address of the destination (host Y 120), which are referred to as Customer MAC Source Address (CMAC-SA) and CMAC-Destination Address (CMAC-DA), respectively. The header may also include a Customer Virtual Local Area Network (CVLAN) that identifies a virtual network. Additionally, the header of Ethernet frame 210A may include a source IP address(SIP), which is the IP address of host X 110, and a destination IP address (DIP), which is the IP address of host Y 120.

According to some aspects, a L2 virtual network can be created over network 101 to provide network services. The L2 virtual network has a VNI that uniquely identifies the virtual network. When edge node 111A receives Ethernet frame 210A from host X 110, edge node 111A assigns the VNI to the Ethernet frame based on CVLAN and determines a unicast transmission scheme for Ethernet frame 210A. Edge node 111A also determines a destination node within network 101 based on the CMAC-DA in the header of Ethernet frame 210A. Throughout the disclosure, an edge node that receives data from a host is also referred to as an ingress node. In some aspects, the ingress node is an ingress BEB. As a non-limiting example, edge node 110A uses key: {CMAC-DA, VNI} in a L2 forwarding lookup table to determine the destination node. If the destination node points to a local UNI port, which means the destination device (e.g., host Y 120) is also connected to edge node 110A, then Ethernet frame 210 can be forwarded to host Y 120 directly.

If the destination node points to an edge node that is remote to the ingress node 111A, then the ingress node 111A encapsulates Ethernet frame 210A into an encapsulated packet 220A. In the example illustrated in FIG. 2A, the destination node in network 101 is edge node 111E, which connects to host Y 120. Throughout the disclosure, an edge node that sends data to a destination host is also referred as an egress node. In some aspects, the egress node is an egress BEB. In some aspects, encapsulation is achieved by adding an encapsulation header to Ethernet frame 210A, and the encapsulation header includes the VNI to identify the virtual network. In some aspects, adding is prepending. For example, the encapsulation is achieved by prepending the encapsulation header to Ethernet frame 210A, and the encapsulation header includes the VNI to identify the virtual network. The encapsulation header can also include the BMAC address of the source node (e.g., ingress node 111A, also referred to as BMAC-SA throughout the disclosure) and the BMAC address of the destination node (e.g., egress node 111E, also referred to as BMAC-DA throughout the disclosure). Additionally, the encapsulation header can include the system IP address of the ingress node 111A, also referred to as backbone IP address of the source (BIP-SA), and the system IP address of the egress node 111E, also referred to as backbone IP address of the destination (BIP-DA). In some aspects, Ethernet frame 210A is encapsulated by Virtual eXtensible Local Area Network (VXLAN) encapsulation. In some aspects, Ethernet frame 210A is encapsulated by VXLAN encapsulation using IPv6 (VXLANv6). In some aspects, Ethernet frame 210A is encapsulated by Generic Network Virtualization Encapsulation (GENEVE). It is to be appreciated that other encapsulation scheme may be used.

According to some aspects, ingress node 111A performs CMAC-SA learning when receives Ethernet frame 210A from host X 110. As a non-limiting example, ingress node 111A adds a key {CMAC-SA, VNI} entry into a L2 forwarding table for future lookups.

According to some aspects, ingress node 111A determines a shortest path to egress node 111E based on a shortest path tree. The shortest path tree can include information of all the nodes from the ingress node to the egress node, as well as egress ports for each nodes. In some aspects, the ingress node 111A uses the IS-IS protocol to compute a shortest path tree based on the IS-IS Link State Database (LSDB), for each node in network 101 as a root node of the tree. ISIS LSDB of network 101 can include the identification, topology, services, and the like of every node in the network. This allows every node to have the same view of the network and compute shortest-path trees consistently. Each shortest path tree includes the shortest paths from the root node to any other destination nodes in the network.

In some aspects, the shortest path tree includes multiple shortest paths. Each shortest path may be assigned an ID based on a hashing algorithm or comparable unique identifier generator function. The hashing algorithm may be based on a VNI, CMAC-SA, CMAC-DA, overlay source IP address, overlay destination IP address, Ethertype, or a combination thereof. It is to be appreciated that the hashing algorithm may be based on other parameters. The shortest path ID may correspond to one of available backbone virtual LAN (B-VLAN) IDs, which are pre-configured for network 101. In some aspects, ingress node 111A determines a shortest path by selecting a B-VLAN ID. The ingress node 111A can encapsulate the B-VLAN ID that identifies the shortest path in the encapsulation header of the encapsulated packet. In some aspects, the shortest path can be identified by a {BMAC-DA, B-VLAN ID} pair, where the BMAC-DA identifies a shortest path tree and the B-VLAN ID identifies the shortest path among one or more shortest paths.

Returning now to the example in FIG. 2A, ingress node 111A can forward encapsulated packet 220A to the next node in the shortest path, and encapsulated packet 220A is forwarded along the shortest path indicated by the arrows from the ingress node 111A to the egress node 111E. In the illustrated example in FIG. 2A, the shortest path includes core node 111B. It is to be appreciated that the shortest path may include more than one core nodes, or may include no core nodes.

In some aspects, core node 111B obtains the system ID of the destination node (e.g., BMAC-DA) and the shortest path information (e.g., B-VLAN ID) from the encapsulation header of encapsulated packet 220A, determines a node in the next hop based on {BMAC-DA, B-VLAN ID} lookup in a L2 forwarding table, and forwards encapsulated packet 210A to the determined node. In some aspects, the L2 forwarding table returns an egress port corresponding to the next node and encapsulated packet 210A is forwarded to the egress port. In some aspects, the {BMAC-DA, B-VLAN ID} entries in the L2 forwarding table are populated by the IS-IS protocol according to the computed shortest path trees. As illustrated by FIG. 2A as a non-limiting example, core node 111B forwards encapsulated packet 220A to egress node 111E along the shortest path determined by ingress node 111A.

According to some aspects, edge node 111E determines that it is the egress node because the BMAC-DA and the BIP-DA in the encapsulation header of encapsulated packet 220A are the same as its own addresses. Egress node 111E de-encapsulates packet 220A by removing the encapsulation header, determines an egress port and transmits Ethernet frame 210A to host Y 120 through the egress port. In some aspects, egress node 111E determines the egress port by performing a L2 table CMAC lookup with key{CMAC-DA, VNI}. In some aspects, egress node 111E performs CMAC-SA learning when obtains Ethernet frame 210A. As a non-limiting example, egress node 111E adds a key {CMAC-SA, VNI} entry into a L2 forwarding table for future lookups.

FIG. 2B illustrates a block diagram for a network environment 200B including a single-area underlay network 101 to provide network services to host devices using unicast according to some aspects. In some aspects, host X 110 is sending a second Ethernet frame 210B to host Y 120, which is different from Ethernet frame 210A of FIG. 2A. The header of Ethernet frame 210B can include CMAC-SA (e.g., MAC address of host X 110), CMAC-DA (e.g., MAC address of host Y 120), the IP address of host X 110, (i.e., SIP), and the IP address of host Y 120, (i.e., DIP).

According to some aspect, ingress node 111A uses the IS-IS protocol to compute a shortest path tree based on the IS-IS LSDB, for each node in network 101 as the root node of the tree. One or more shortest paths with equal cost can be determined from a shortest path tree with the ingress node as the root node of the tree. Ingress node 111A selects a shortest path from one or more shortest paths with equal cost by selecting a B-VLAN ID. In some aspects, the selected shortest path for transmitting Ethernet frame 210B is different from the shortest path used for transmitting Ethernet frame 210A of FIG. 2A. Using different path with equal cost for different data frame can reduce the load of a particular path.

Returning now to the example in FIG. 2B, ingress node 111A can encapsulate Ethernet frame 210B into an encapsulated packet 220B by adding an encapsulation header to Ethernet frame 210B. The encapsulation header can include the B-VLAN ID that identifies the selected shortest path. As illustrated by FIG. 2B as a non-limiting example, the encapsulated packet 220B is forwarded along the shortest path indicated by the arrows from the ingress node 111A to the egress node 111E and the shortest path includes core node 111C.

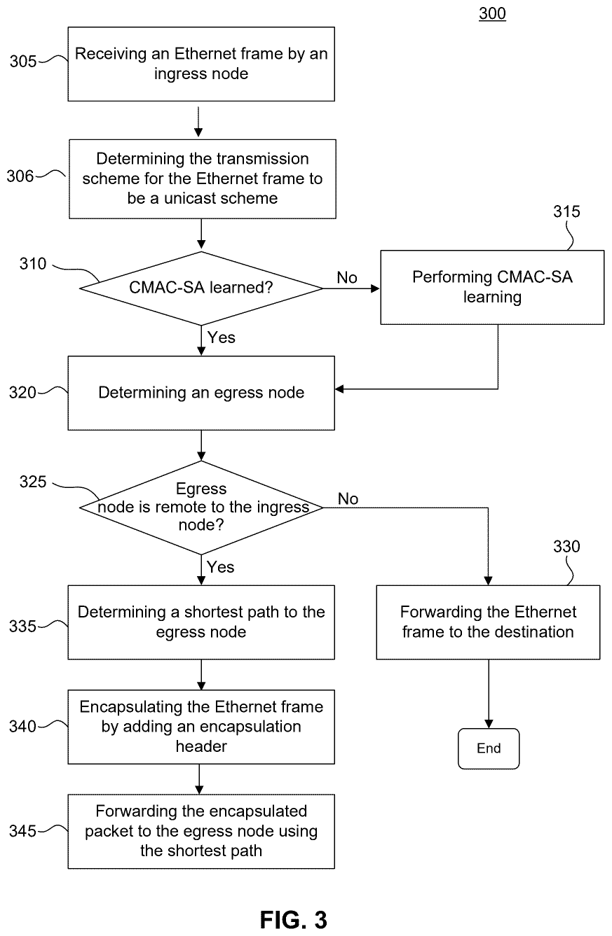

FIG. 3 is a flow chart illustrating an example method 300 performed by an ingress node for network services using unicast according to some aspects of the disclosure. For example, method 300 may be performed by ingress node 111A in FIGS. 2A and 2B. As a convenience and not a limitation, FIG. 3 may be described with regard to elements of FIGS. 2A and 2B. Method 300 is not limited to the specific aspects depicted in those figures and other systems may be used to perform the method as will be understood by those skilled in the art. It is to be appreciated that not all operations may be needed, or additional operations may be needed, and the operations may not be performed in the same order as shown in FIG. 3.

In 305, an overlay Ethernet frame (for example Ethernet frame 210A of FIG. 2A or Ethernet frame 210B of FIG. 2B) is received by an ingress node (for example, edge node 111A of FIGS. 2A and 2B) from host X 110 intended for host Y 120. In some aspects, the ingress node is an ingress BEB. The header of the Ethernet frame may include CMAC-SA (e.g., the MAC addresses of the host X 110), CMAC-DA (e.g., the MAC address of the host Y 120), and CVLAN. The header of the Ethernet frame may also include the IP address of host X 110 (e.g., SIP), and the IP address of host Y 120 (e.g., DIP).

In 306, the ingress node determines a transmission scheme for the overlay Ethernet frame based on CMAC-DA and VNI. The VNI identifies a L2 virtual network that provides the desired service to the overlay Ethernet frame. In some aspect, if a lookup of the key {CMAC-DA, VNI} in the L2 forwarding table is successful, the ingress node will determine to use unicast as the transmission scheme. In some aspect, the determination is based on incoming port and/or the CVLAN attribute of the overlay Ethernet frame.

In 310, the ingress node determines if the CMAC-SA from the overlay Ethernet frame has been learned. For example, the ingress node checks if the key {CMAC-SA, VNI} is in the L2 forwarding table, where VNI identifies the L2 virtual network that provides the network service. If not, the ingress node performs CMAC-SA learning by adding the key {CMAC-SA, VNI} and ingress port associated with the key into the L2 forwarding table in operation 315. In some aspects, if the key {CMAC-SA, VNI} is in the L2 forwarding table but the destination associated with the key is different, destination for the entry associated with the key is replaced with the ingress port in the L2 forwarding table. Otherwise, method 300 proceeds to operation 320.

In 320, an egress node is determined based on the CMAC-DA obtained from the header of the Ethernet frame and the VNI. For example, method 300 includes using key: {CMAC-DA, VNI} in a L2 forwarding lookup table to determine the egress node.

In 325, if the egress node is the same as the ingress node for example, the egress node points to a local UNI, method 300 proceeds to operation 330. If the egress node is different from the ingress node, method 300 proceeds to operation 335.

In 330, the Ethernet frame is forwarded to the local UNI by the ingress node and method 300 terminates.

In 335, a shortest path to the egress node (for example, edge node 111E of FIGS. 2A and 2B) is determined based on a shortest path tree computed using IS-IS LSDB by the ingress node. In some aspects, method 300 includes using the IS-IS protocol to compute a shortest path tree for each node as the root node based on the IS-IS LSDB. Each shortest path tree can include information of all the nodes from the root node to a destination node, as well as egress ports for each nodes. One or more shortest paths are available and each shortest path can be identified by a unique identifier, such as B-VLAN ID based on a hashing algorithm. In some aspects, a shortest path is selected by selecting a B-VLAN ID. In some aspects, the shortest path can be identified by a {BMAC-DA, B-VLAN ID} pair, where the BMAC-DA identifies a shortest path tree and the B-VLAN ID identifies the shortest path among one or more shortest paths.

In 340, the Ethernet frame is encapsulated by adding an encapsulation header by the ingress node. The encapsulation header can include the VNI to identify the virtual network, and B-VLAN ID to identify the shortest path selected by the ingress node. The encapsulation header also includes BMAC-SA, e.g., the BMAC address of the source, (for example, ingress node 111A of FIGS. 2A and 2B), and BMAC-DA, e.g., the BMAC address of the destination, (for example, egress node 111E of FIGS. 2A and 2B). Additionally, the encapsulation header can include the IP addresses of the ingress node and the egress node. As non-limiting examples, the encapsulation can be the VXLAN encapsulation, the VXLANv6 encapsulation, or the GENEVE.

In 345, the encapsulated packet (for example, encapsulated packet 220A of FIG. 2A, or encapsulated packet 220B of FIG. 2B) is forwarded along the shortest path from the ingress node (for example, edge node 111A of FIGS. 2A and 2B) to the egress node (for example, edge node 111E of FIGS. 2A and 2B).

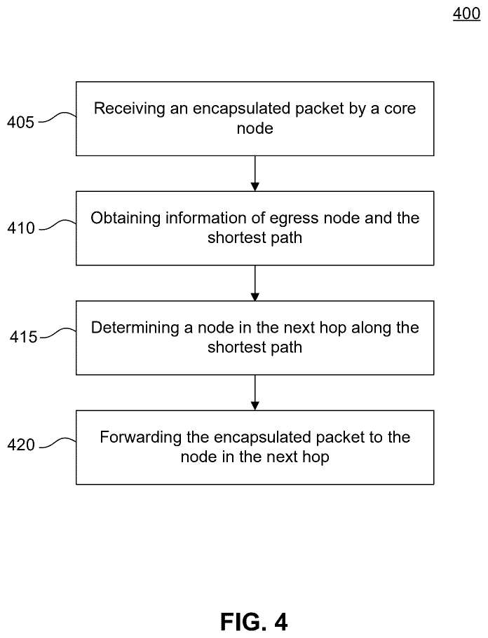

FIG. 4 is a flow chart illustrating an example method 400 performed by a core node, for forwarding underlay network packets, according to some aspects of the disclosure. For example, method 400 may be performed by core nodes 111B and 111C in FIGS. 2A and 2B. As a convenience and not a limitation, FIG. 4 may be described with regard to elements of FIGS. 2A and 2B. Method 400 is not limited to the specific aspects depicted in those figures and other systems may be used to perform the method as will be understood by those skilled in the art. It is to be appreciated that not all operations may be needed, or additional operations may be needed, and the operations may not be performed in the same order as shown in FIG. 4.

In 405, an encapsulated packet (for example, packet 220A in FIG. 2A or packet 220B in FIG. 2B) is received by a core node, (for example, node 111B in FIG. 2A or node 111C in FIG. 2B). In some aspects, the core node is a BCB.

In 410, information about egress node and the shortest path is obtained by, for example, the core node from the header of the encapsulated packet. Such information can include system ID of the egress node (e.g., BMAC-DA) and the shortest path ID (e.g., B-VLAN ID).

In 415, a node in the next hop along the shortest path is determined by, for example, the core node, for example, by using the key: {BMAC-DA, B-VLAN ID} to lookup in a L2 forwarding table. In some aspects, the L2 forwarding table returns an egress port corresponding for the next node alone the shortest path. In some aspects, the {BMAC-DA, B-VLAN ID} entries in the L2 forwarding table are populated by the IS-IS protocol according to the computed shortest path tree.

In 420, the core node forwards the encapsulated packet to the node in the next hop along the shortest path.

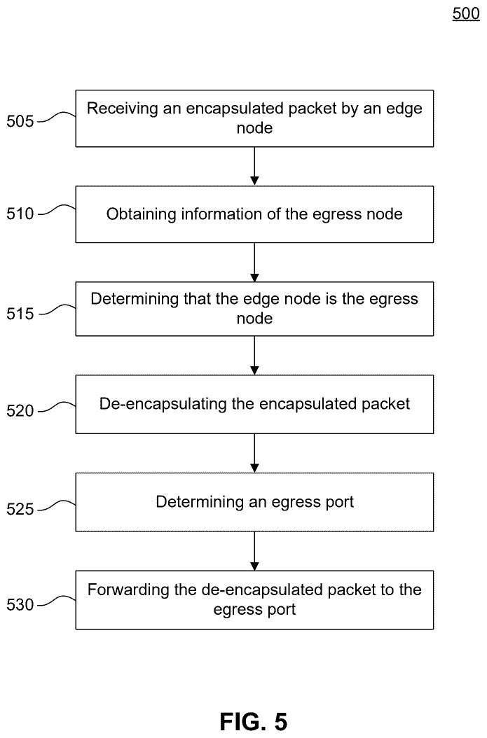

FIG. 5 is a flow chart illustrating an example method 500 performed by an edge node, for forwarding underlay network packets, according to some aspects of the disclosure. For example, method 500 may be performed by edge node 111E in FIGS. 2A and 2B. As a convenience and not a limitation, FIG. 5 may be described with regard to elements of FIGS. 2A and 2B. Method 500 is not limited to the specific aspects depicted in those figures and other systems may be used to perform the method as will be understood by those skilled in the art. It is to be appreciated that not all operations may be needed, or additional operations may be needed, and the operations may not be performed in the same order as shown in FIG. 5.

In 505, an encapsulated packet (for example, packet 220A in FIG. 2A or packet 220B in FIG. 2B) is received by an edge node, (for example, node 111E in FIGS. 2A and 2B). In some aspects, the edge node is a BEB.

In 510, the edge node obtains information about the egress node from the header of the encapsulated packet. Such information can include system ID of the egress node (e.g., BMAC-DA) and system IP of the egress node (e.g., BIP-DA).

In 515, the edge node determines that the edge node is the egress node by comparing the system ID and system IP of the edge node with BMAC-DA and BIP-DA.

In 520, the edge node de-encapsulates the encapsulated packet by removing the encapsulation header.

In 525, the edge node determines an egress port corresponding to the destination host (e.g., host Y 120 in FIGS. 2A and 2B). In some aspects, determining the egress port is achieved by performing a L2 table CMAC lookup with key: {CMAC-DA, VNI}.

In 530, the edge node forwards the de-encapsulated packet (e.g., Ethernet frame 210A in FIGS. 2A and 2B) to the egress port.

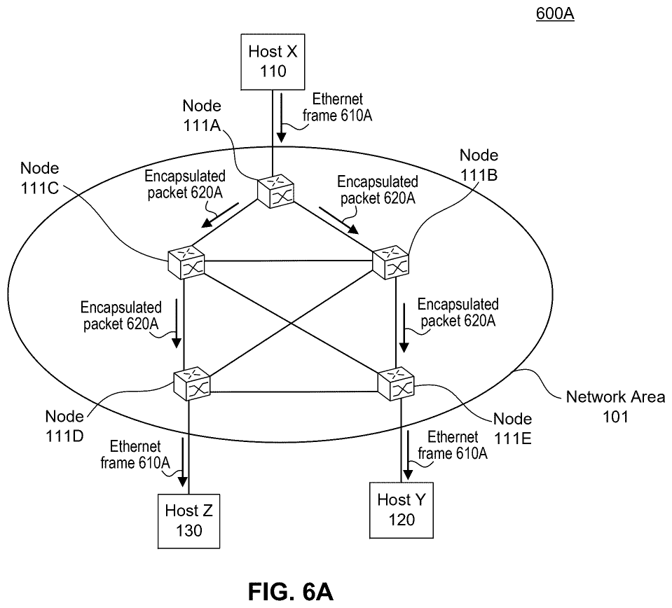

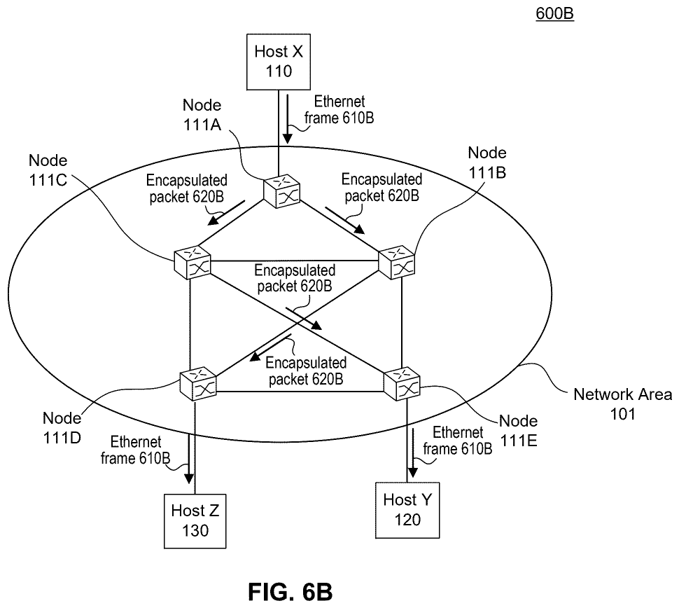

FIG. 6A illustrates a block diagram for a network environment 600A including a single-area underlay network 101 to provide network services using broadcast, unknown unicast or multicast (BUM) to a group of host devices, according to some aspects. In some aspects, host X 110 accesses underlay network 101 for sending data to host Y 120 and host Z 130 using BUM. Data can be included in an Ethernet frame 610A. The header of Ethernet frame 610A can include CMAC-SA, i.e., the MAC address of the source (host X 110), CMAC-DA, e.g., a broadcast MAC address (e.g., FF:FF:FF:FF:FF:FF), and a CVLAN that identifies a service desired by host X 110, e.g., a BUM service.

According to some aspects, a L2 virtual network can be created over network 101 to provide network services. When ingress node 111A receives Ethernet frame 610A from host X 110, ingress node 111A determines a BUM transmission scheme for Ethernet frame 610A. Using broadcast as an example, the L2 virtual network has a VNI that uniquely identifies the virtual service network. Ingress node determines that it is a broadcast frame based on the CMAC-DA and/or CVLAN in the header of Ethernet frame 610A and classifies Ethernet frame 610A into the VNI. In some aspects, the ingress node is an ingress BEB.

According to some aspects, ingress node 111A encapsulates Ethernet frame 610A into an encapsulated packet 620A. In some aspects, encapsulation is achieved by adding an encapsulation header to Ethernet frame 610A, and the encapsulation header includes the VNI to identify the L2 virtual network that Ethernet frame 610A is using. The encapsulation header can also include BMAC-SA, e.g., the BMAC address of ingress node 111A, and a multicast tree ID, e.g., BMAC-DA. In some aspects, for BUM services, BMAC-DA identifies a group of destination nodes in an IP Multicast group. In some aspects, BMAC-DA can be derived based on a nickname of ingress node 111A and the VNI. A node's nickname can be uniquely derived from the system IP address of the node. In some aspects, a node's nickname may correspond to a predefined number of least significant bits of an IP address of the node. As a non-limiting example, a nickname of a node is the last 20 bits of a system IP of the node. For example, if the system IP address of ingress node 111A is 10.1.0.10, then ingress node 111A's nickname is 1:00:0A. If a value of the VNI is 10 (i.e., 00:00:0A), then BMAC-DA is 1:00:0A:00:00:0A.

Additionally, the encapsulation header can include BIP-SA, i.e., the system IP address of the ingress node 111A, and BIP-DA, i.e., a group system IP address of the destination nodes. In some aspects, the group system IP address of the destination nodes is an IP Multicast group address. In some aspects, the IP Multicast group address is derived from VNI and identifies all the nodes in the VNI that will receive BUM packets. As a non-limiting example, the last 24 bits of the IP Multicast address is the VNI. In some aspects, Ethernet frame 610A is encapsulated by VXLAN encapsulation. In some aspects, Ethernet frame 610A is encapsulated by VXLANv6 encapsulation. In some aspects, Ethernet frame 610A is encapsulated by GENEVE. It is to be appreciated that other encapsulation scheme may be used.

According to some aspects, ingress node 111A performs CMAC-SA learning when receives Ethernet frame 610A from host X 110. As a non-limiting example, ingress node 111A adds a key {CMAC-SA, VNI} entry into a L2 forwarding table for future lookups.

According to some aspects, ingress node 111A determines a shortest path tree to all the egress nodes (e.g., egress nodes 111D and 111E as illustrated in FIG. 6A) that will receive the BUM frame using the BUM service based on BMAC-DA. There can be a shortest path tree for each node per each unique service, and the shortest path trees can be computed based on the IS-IS LSDB of network 101. In some aspects, the ingress node 111A uses the IS-IS protocol to compute a shortest path tree based on the IS-IS LSDB for each node in network 101 as a root node of the tree. Each shortest path tree can be uniquely identified by BMAC-DA, which is based on the nickname of the source (i.e., ingress node 111A) and the service (i.e., VNI).

In some aspects, there are one or more shortest paths from the ingress node 111A to each of the egress nodes. Each shortest path can be assigned an ID based on a hashing algorithm or comparable unique identifier generator function. The hashing algorithm may be based on a VNI, CMAC-SA, CMAC-DA, overlay source IP address, overlay destination IP address, Ethertype, or a combination thereof. It is to be appreciated that the hashing algorithm may be based on other parameters. The shortest path ID may correspond to one of available B-VLAN IDs. In some aspects, ingress node 111A determines a shortest path by selecting a B-VLAN ID. Ingress node 111A encapsulates the B-VLAN ID that identifies the shortest path in the encapsulation header of the encapsulated packet. In some aspects, the shortest path is determined based on looking up key {BMAC-DA, B-VLAN ID} in a L2 forwarding table.

According to some aspects, the IS-IS protocol updates LSDB using TLV encoding scheme and the TLV data may include BIP addresses of underlay network nodes (e.g., nodes 111A~111E of network 101), and an overlay IP Multicast group address. In some aspects, ingress node 111A uses the IS-IS protocol to compute the shortest path trees based on the IS-IS LSDB. The shortest path trees can be uniquely identified by a Source, Group value of a (S, G, V) triplet. The (S, G, V) value may be represented by an array containing a source IP address, a group IP address and a VLAN value. In the example illustrated in FIG. 6A, the (S, G, V) value can be an array containing the source IP address of ingress node 111A, (i.e., BIP-SA), the IP Multicast group address derived from VNI, (i.e., BIP-DA), and the B-VLAN ID. In some aspects, the shortest path is determined based on looking up (S, G, V) values equaling (BIP-SA, BIP-DA, B-VLAN ID) in a forwarding table.

Returning now to the example in FIG. 6A, encapsulated packet 620A is duplicated by ingress node 111A and duplicated packets 620A are forwarded along the shortest paths indicated by the arrows from ingress node 111A to all egress nodes 111D and 111E. The shortest path to egress node 111D includes core node 111C and the shortest path to egress node 111E includes core node 111B. It is to be appreciated that the shortest path may include more than one core nodes, or may include no core nodes.

In some aspects, core nodes 111C and 111B obtain BMAC-DA and the shortest path information (e.g., B-VLAN ID) from the encapsulation header of encapsulated packet 620A, determine one or more nodes in the next hop based on the {BMAC-DA, B-VLAN ID} lookup in a L2 forwarding table, and forward encapsulated packets 620A to the nodes in the next hop. In some aspects, the L2 forwarding table returns one or more egress ports corresponding to the next nodes and encapsulated packets 620A are forwarded to the egress ports. In some aspects, the {BMAC-DA, B-VLAN ID} entries in the L2 forwarding table are populated by the IS-IS protocol according to the computed shortest path tree.

In some aspects, core nodes 111C and 111B obtain the (S, G, V) value from the encapsulation header of the encapsulated packet 620A, determine one or more nodes in the next hop based on the (S, G, V) lookup in a L2 forwarding table, and forwards encapsulated packet 620A to the determined nodes. As illustrated by FIG. 6A as a non-limiting example, core nodes 111C and 111B forward encapsulated packet 620A to egress nodes 111D and 111E along their respective shortest path.

According to some aspects, egress nodes 111D and 111E de-encapsulate packet 620A by removing the encapsulation header, determine an egress port and transmit Ethernet frame 610A to host Z 130 and host Y 120 through their respective egress port.

FIG. 6B illustrates a block diagram for a network environment 600B including a single-area underlay network 101 to provide network services to a group of host devices using BUM according to some aspects. In some aspects, host X 110 broadcasts a second Ethernet frame 610B, which is different from Ethernet frame 610A of FIG. 6A. The header of Ethernet frame 610B includes CMAC-SA (e.g., MAC address of host X 110), CMAC-DA (e.g., broadcast MAC address).

According to some aspect, ingress node 111A selects a different B-VLAN ID for transmission, which represents different shortest paths from ingress node 111A to egress nodes. The shortest paths to each egress node as illustrated in FIG. 6B is different from those of FIG. 6A, but with equal cost. Using different paths with equal cost for different data frame can reduce the load of a particular path.

Returning now to the example in FIG. 6B, ingress node 111A can encapsulate Ethernet frame 610B into an encapsulated packet 620B by appending an encapsulation header to Ethernet frame 610B. The encapsulation header can include the selected B-VLAN ID that identifies the selected shortest paths. As illustrated by FIG. 6B as a non-limiting example, encapsulated packet 620B is duplicated by ingress node 111A, and duplicated packets 620B are forwarded along the shortest paths indicated by the arrows from ingress node 111A to all egress nodes 111D and 111E. The shortest path to egress node 111D includes core node 111B and the shortest path to egress node 111E includes core node 111C.

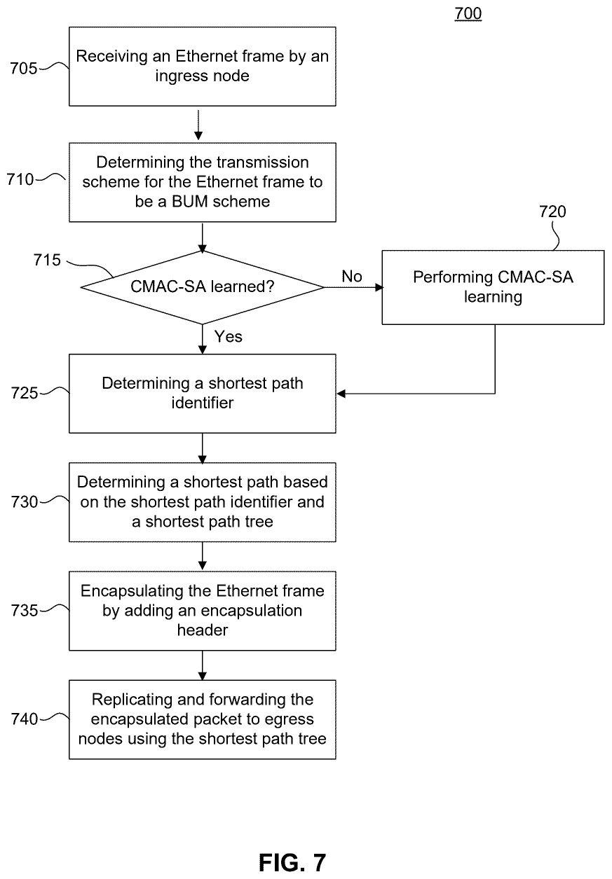

FIG. 7 is a flow chart illustrating an example method 700 performed by an ingress node for a network service using BUM according to some aspects of the disclosure. For example, method 700 may be performed by the ingress node 111A in FIGS. 6A and 6B. As a convenience and not a limitation, FIG. 7 may be described with regard to elements of FIGS. 6A and 6B. Method 700 is not limited to the specific aspects depicted in those figures and other systems may be used to perform the method as will be understood by those skilled in the art. It is to be appreciated that not all operations may be needed, or additional operations may be needed, and the operations may not be performed in the same order as shown in FIG. 7.

In 705, an overlay Ethernet frame (for example Ethernet frame 610A of FIG. 6A or Ethernet frame 610B of FIG. 6B) is received by an ingress node (for example, edge node 111A of FIGS. 6A and 6B) from host X 110. In some aspects, the ingress node is an ingress BEB and the Ethernet frame is a broadcast frame. The header of the Ethernet frame includes CMAC-SA (e.g., the MAC addresses of the host X 110), CMAC-DA (e.g., a broadcast MAC address), and CVLAN.

In 710, the ingress node determines a transmission scheme for the overlay Ethernet frame based on CMAC-DA and a VNI value. The VNI identifies a L2 virtual network that provides the desired service to the overlay Ethernet frame. In some aspect, if a lookup of the key {CMAC-DA, VNI} in the L2 forwarding table is unsuccessful, the ingress node will determine to use BUM as the transmission scheme. In some aspect, the determination is based on incoming port and/or the CVLAN attribute of the overlay Ethernet frame.

In 715, the ingress node determines if the CMAC-SA from the overlay Ethernet frame has been learned. For example, the ingress node checks if the key {CMAC-SA, VNI} is in the L2 forwarding table. If not, the ingress node performs CMAC-SA learning by adding the key {CMAC-SA, VNI} into the L2 forwarding table in operation 720. Otherwise, method 700 proceeds to operation 725.

In 725, the ingress node determines a shortest path ID. In some aspects, there are one or more shortest paths from the ingress node 111A to each of the egress nodes. Each shortest path can be assigned an ID based on a hashing algorithm or comparable unique identifier generator function. The hashing algorithm may be based on a VNI, CMAC-SA, CMAC-DA, overlay source IP address, overlay destination IP address, Ethertype, or a combination thereof. The shortest path ID may correspond to one of available B-VLAN IDs. In some aspects, ingress node 111A determining a shortest path by selecting a B-VLAN ID.

In 730, the ingress node determines a shortest path based on the shortest path ID (e.g., B-VLAN ID) and a shortest path tree with the ingress node 111A as the root node. In some aspects, there is one shortest path tree for each node in the network per each unique service provided by the underlay network. The shortest path trees are computed based on the IS-IS LSDB of the underlay network (e.g., network 101 of FIGS. 6A and 6B). For example, ingress node 111A uses the IS-IS protocol to compute a shortest path tree based on the IS-IS LSDB, for each network node as the root node. Each shortest path tree can be uniquely identified by BMAC-DA, which is based on both the nickname of the source (e.g., ingress node 111A) and the service (e.g., VNI). In some aspects, the shortest path can be identified by a {BMAC-DA, B-VLAN ID} pair in a L2 forwarding table, where the BMAC-DA identifies a shortest path tree and the B-VLAN ID identifies the shortest path among one or more shortest paths.

In some aspect, the shortest path tree is uniquely identified by a Source, Group value of a (S, G, V) triplet. The (S, G, V) value may be represented by an array containing the source IP address of ingress node 111A, (e.g.,, BIP-SA), the IP Multicast group address derived from VNI, (e.g., BIP-DA), and B-VLAN ID.

In 735, the ingress node encapsulates the Ethernet frame by adding an encapsulation header. In some aspects, adding is prepending. In some aspects, the encapsulation header can include the VNI to identify that the Ethernet frame is using the BUM service, and B-VLAN ID to identify the shortest path selected by the ingress node. The encapsulation header can also include BMAC-SA, i.e., the BMAC address of the source, (for example, ingress node 111A of FIGS. 6A and 6B), and BMAC-DA, i.e., the multicast tree ID. In some aspects, BMAC-DA can be derived based on a nickname of ingress node 111A and the VNI. Additionally, the encapsulation header can include the IP addresses of the ingress node 111A (e.g., BIP-SA) and the IP Multicast group address (e.g., BIP-DA). As non-limiting examples, encapsulation may be using VXLAN encapsulation, VXLANv6 encapsulation, or GENEVE.

In 740, the ingress node replicates the encapsulated packet into two or more identical encapsulated packets (for example, encapsulated packet 620A of FIG. 6A, or encapsulated packet 620B of FIG. 6B) and forwards the replicated packets along the shortest paths from the ingress node (for example, edge node 111A of FIGS. 6A and 6B) to egress nodes (for example, egress nodes 111D, 111E of FIGS. 6A and 6B).

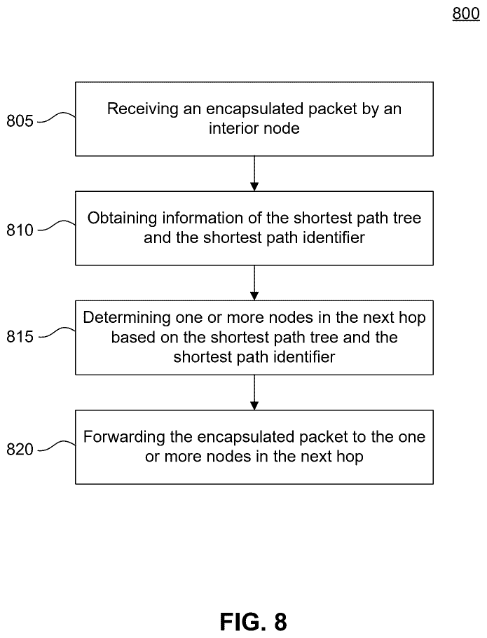

FIG. 8 is a flow chart illustrating an example method 800 performed by a core node, for forwarding underlay network packets, according to some aspects of the disclosure. For example, method 800 may be performed by core nodes 111B and 111C in FIGS. 6A and 6B. As a convenience and not a limitation, FIG. 8 may be described with regard to elements of FIGS. 6A and 6B. Method 800 is not limited to the specific aspects depicted in those figures and other systems may be used to perform the method as will be understood by those skilled in the art. It is to be appreciated that not all operations may be needed, or additional operations may be needed, and the operations may not be performed in the same order as shown in FIG. 8.

In 805, an encapsulated packet (for example, packet 620A in FIG. 6A or packet 620B in FIG. 6B) is received by a core node, (for example, node 111B in FIG. 6A or node 111C in FIG. 6B). In some aspects, the core node is a BCB.

In 810, the core node obtains information that identifies the shortest path tree and the shortest path ID (e.g., B-VLAN ID) from the header of the encapsulated packet. As already discussed, in some aspects, the shortest path tree with ingress node 111A as the root node can be uniquely identified by BMAC-DA, which is derived from the nickname of ingress node 111A and service identifier VNI. In some aspects, the shortest path tree can be uniquely identified by a Source, Group value of a (S, G, V) triplet. The (S, G, V) value may be represented by an array containing the source IP address of ingress node 111A (e.g., BIP-SA), the IP Multicast group address derived from VNI, (e.g., BIP-DA), and the B-VLAN ID.

In 815, the core node determines one or more nodes in the next hop based on the shortest path tree and the shortest path ID. In some aspects, the one or more nodes are determined by using the key: {BMAC-DA, B-VLAN ID} to lookup in a L2 forwarding table. The L2 forwarding table may return one or more egress ports corresponding for the one or more nodes alone the shortest paths. In some aspects, the {BMAC-DA, B-VLAN ID} entries in the L2 forwarding table are populated by the IS-IS protocol according to the computed shortest path trees. In some aspects, the one or more nodes are determined by using the (S, G, V) value lookup in a LSDB of the underlay network (e.g., network 101 of FIGS. 6A and 6B). For example, determining the one or more nodes based on searching the LSDB of the underlay network for a table entry containing the source IP address (e.g., BIP-SA), the IP Multicast group address (e.g., BIP-DA), and B-VLAN values equaling the (S, G, V) value array. In some aspects, the (S, G, V) value arrays are populated by the IS-IS protocol.

In 820, the core node forwards the encapsulated packets to the one or more nodes in the next hop.

According to some aspects, a L3 virtual network can be created over an underlay network (e.g., network 101 of FIGS. 1, 2A, 2B, 6A, 6B) to provide network services for host nodes (e.g., host X 110, host Y 120, host Z 130 of FIGS. 1, 2A, 2B, 6A, 6B) using unicast schemes. For example, an overlay Ethernet frame (e.g., Ethernet frame 210A of FIG. 2A, Ethernet frame 210B of FIG. 2B, Ethernet frame 610A of FIG. 6A, or Ethernet frame 610B of FIG. 6B) is received by an ingress node (e.g., edge node 111A of FIGS. 2A, 2B, 6A, 6B). It is an IPv4 or IPv6 unicast packet and its CMAC-DA and determined L2 VNI match an overlay routing interface of the ingress node. In some aspects, routing of the packet is based on the overlay destination IP address in a routing table. In some aspects, the underlay network nodes use key: {DIP, VNI} in a L3 virtual routing and forwarding table to determine the IP address of the node in the next hop. The L3 virtual routing and forwarding table can be populated by the IS-IS protocol.

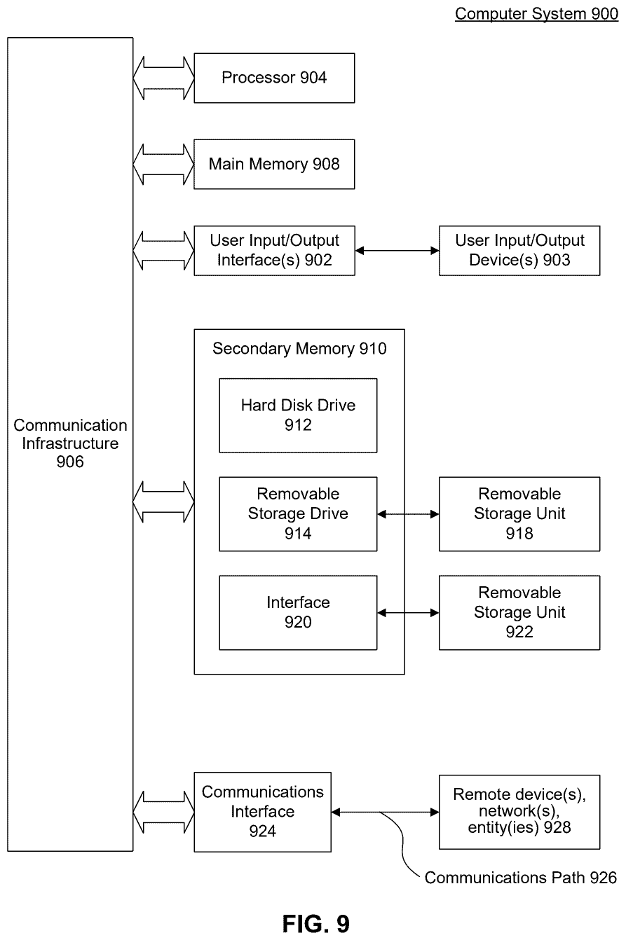

FIG. 9 illustrates a diagram of a general-purpose computer that can be used to perform various aspects of the present disclosure, according to some aspects. Various aspects can be implemented, for example, using one or more well-known computer systems, such as computer system 900 shown in FIG. 9. One or more computer systems 900 can be used, for example, to implement any aspect of the disclosure discussed herein, such as, single-area network 101, nodes 111, host devices 110, 120, 130, as well as any combinations and sub-combinations thereof.

Computer system 900 can include one or more processors (also called central processing units, or CPUs), such as a processor 904. Processor 904 can be connected to a communication infrastructure or bus 906.

Computer system 900 can also include customer input/output device(s) 903, such as monitors, keyboards, pointing devices, etc., which can communicate with communication infrastructure 906 through customer input/output interface(s) 902.

One or more of processors 904 can be a graphics processing unit (GPU). In an aspect, a GPU can be a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 900 can also include a main or primary memory 908, such as random access memory (RAM). Main memory 1008 can include one or more levels of cache. Main memory 908 can have stored therein control logic (i.e., computer software) and/or data.

Computer system 900 can also include one or more secondary storage devices or memory 910. Secondary memory 910 can include, for example, a hard disk drive 912 and/or a removable storage device or drive 914. Removable storage drive 914 can be a floppy disk drive, a magnetic tape drive, a compact disk drive, an optical storage device, tape backup device, and/or any other storage device/drive.

Removable storage drive 914 can interact with a removable storage unit 918. Removable storage unit 918 can include a computer usable or readable storage device having stored thereon computer software (control logic) and/or data. Removable storage unit 918 can be a floppy disk, magnetic tape, compact disk, DVD, optical storage disk, and/any other computer data storage device. Removable storage drive 914 can read from and/or write to removable storage unit 918.

Secondary memory 910 can include other means, devices, components, instrumentalities or other approaches for allowing computer programs and/or other instructions and/or data to be accessed by computer system 900. Such means, devices, components, instrumentalities or other approaches can include, for example, a removable storage unit 922 and an interface 920. Examples of the removable storage unit 922 and the interface 920 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 can further include a communication or network interface 924. Communication interface 924 can enable computer system 900 to communicate and interact with any combination of external devices, external networks, external entities, etc. (individually and collectively referenced by reference number 928). For example, communication interface 924 can allow computer system 900 to communicate with external or remote devices 928 over communications path 926, which can be wired and/or wireless (or a combination thereof), and which can include any combination of LANs, WANs, the Internet, etc. Control logic and/or data can be transmitted to and from computer system 1000 via communication path 926.

Computer system 900 can also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 can be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 can be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas can be used, either exclusively or in combination with known or open standards.

In some aspects, a tangible, non-transitory apparatus or article of manufacture including a tangible, non-transitory computer useable or readable medium having control logic (software) stored thereon can also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), can cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 9. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References herein to “one aspect,” “an aspect,” “an example aspect,” “some aspects,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

These and other valuable aspects of the aspects of the present disclosure consequently further the state of the technology to at least the next level. While the disclosed aspects have been described as the best mode of implementing the single-area SPBX network for overlay IP unicast or multicast packets, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the breadth and scope of this disclosure should not be limited by any of the above-described exemplary aspects, but should be defined only in accordance with the following claims and their equivalents.

The breadth and scope of the disclosure should not be limited by any of the above-described exemplary aspects, but should be defined only in accordance with the following claims and their equivalents.

What is claimed is:

1. A method, comprising:
receiving, by a first network node of an underlay network, an overlay Ethernet frame from a first host node;
determining, by the first network node, a transmission scheme for the overlay Ethernet frame, wherein the transmission scheme is one of a unicast scheme, or a broadcast, unknown unicast or multicast (BUM) scheme;
determining, by the first network node, a second network node for receiving the overlay Ethernet frame;
determining, by the first network node, a shortest path from the first network node to the second network node;
encapsulating, by the first network node, the overlay Ethernet frame into an encapsulated packet by adding an encapsulation header, wherein the encapsulation header comprises information of the first network node, a service identifier (ID), and an ID of the shortest path; and
transmitting the IP packet to the second network node based on the shortest path.

2. The method of claim 1, wherein the first network node comprises an Intermediate System to Intermediate System (ISIS) link state database (LSDB) associated with the underlay network.

3. The method of claim 2, wherein determining the shortest path comprises:
identifying a shortest path tree based on a nickname of the first network node and the service ID, wherein the nickname corresponds to a predefined number of least significant bits of an IP address of the first network node; and
determining the ID of the shortest path using a hashing algorithm.

4. The method of claim 2, wherein the ISIS LSDB includes system IP addresses of underlay network nodes, and wherein determining the shortest path comprises:
identifying a shortest path tree based on a system IP address of the first network node and a group IP address; and
determining the ID of the shortest path using a hashing algorithm.

5. The method of claim 1, wherein the encapsulation header further comprises a first system ID of the first network node, a first system IP address of the first network node, a multicast tree ID and an IP Multicast group address.

6. The method of claim 1, wherein the encapsulation header further comprises a first system ID of the first network node, a first system IP address of the first network node, a second system ID of the second network node and a second system IP address of the second network node.

7. The method of claim 1, further comprising:
receiving, by the first network node, a second overlay Ethernet frame from the first host node;
determining, by the first network node, a second shortest path from the first network node to the second network node, wherein the second shortest path is different from the shortest path;
encapsulating, by the first network node, the second overlay Ethernet frame into a second encapsulated packet by adding a second encapsulation header, wherein the second encapsulation header comprises the service ID and a second ID of the second shortest path; and
transmitting the second encapsulated packet to the second network node based on the second shortest path.

8. One or more tangible computer-readable devices having instructions stored thereon that, when executed by one or more network nodes in an underlay network, causes the one or more network nodes to perform operations comprising:
receiving an overlay Ethernet frame from a first host node;
determining a transmission scheme for the overlay Ethernet frame, wherein the transmission scheme is one of a unicast scheme, or a broadcast unknown unicast or multicast (BUM) scheme;
determining a second network node for receiving the overlay Ethernet frame ;
determining a shortest path from the first network node to the second network node;
encapsulating the overlay Ethernet frame into an encapsulated packet by adding an encapsulation header, wherein the encapsulation header comprises a service identifier (ID) and an ID of the shortest path; and
transmitting the encapsulated packet to the second network node based on the shortest path.

9. The one or more tangible computer readable devices of claim 8 comprise an Intermediate System to Intermediate System (ISIS) link state database (LSDB) associated with the network area.

10. The one or more tangible computer readable devices of claim 9, wherein determining the shortest path comprises:
identifying a shortest path tree based on a nickname of the first network node and the service ID; wherein the nickname corresponds to a predefined number of least significant bits of an IP address of the first network node; and
determining the ID of the shortest path using a hashing algorithm.

11. The one or more tangible computer readable devices of claim 9, wherein the ISIS LSDB includes system IP addresses of underlay network nodes, and wherein determining the shortest path comprises:
identifying a shortest path tree based on a system IP address of the first network node and a group IP address; and
determining the ID of the shortest path using a hashing algorithm.

12. The one or more tangible computer readable devices of claim 8, wherein the first encapsulation header comprises a first system ID of the first network node, a first system IP address of the first network node, a multicast tree ID and an IP Multicast group address.

13. The one or more tangible computer readable devices of claim 8, wherein the encapsulation header further comprises a first system ID of the first network node, a first system IP address of the first network node, a second system ID of the second network node and a second system IP address of the second network node.

14. The one or more tangible computer readable devices of claim 8, the operations further comprising:
receiving a second overlay Ethernet frame from the first host;
determining a second shortest path from the first network node to the second network node, wherein the second shortest path is different from the first shortest path;
encapsulating the second overlay Ethernet frame into a second encapsulated packet by adding a second encapsulation header, wherein the second encapsulation header comprises a service ID, a second ID of the second shortest path; and
transmitting the second encapsulated packet to the second network node based on the second shortest path.

15. An underlay network system comprises:
a first backbone edge bridge (BEB) configured to:
receive an overlay Ethernet frame from a first host node;
determine a transmission scheme for the overlay Ethernet frame, wherein the transmission scheme is one of a unicast scheme, or a broadcast, unknown unicast or multicast (BUM) scheme ;
determine a second BEB for receiving the overlay Ethernet frame;
determine a shortest path from the first BEB to the second BEB; and
encapsulate the overlay Ethernet frame into an encapsulated packet by adding an encapsulation header, wherein the encapsulation header comprises information of the first network node, a service identifier (ID), and an ID of the shortest path; and
a backbone core bridge (BCB) configured to:
forward the encapsulated packet according to the shortest path from the first BEB to the second BEB.

16. The underlay network of claim 15, wherein each of the first BEB, the second BEB and the BCB comprises an Intermediate System to Intermediate System (ISIS) link state database (LSDB) associated with the underlay network.

17. The underlay network of claim 16, wherein the first BEB is further configured to:
identify a shortest path tree based on a nickname of the first BEB and the service ID; wherein the nickname corresponds to a predefined number of least significant bits of an IP address of the first BEB; and
determine the ID of the shortest path using a hashing algorithm.

18. The underlay network of claim 16, wherein the ISIS LSDB includes system IP addresses of underlay network nodes and wherein the first BEB is further configured to:
identify a shortest path tree based on a system IP address of the first BEB and a group IP address; and
determine the ID of the shortest path using a hashing algorithm.

19. The underlay network of claim 15, wherein the encapsulation header further comprises a first system ID of the first BEB, a first system IP address of the first BEB, a multicast tree ID and an IP Multicast group address.

20. The underlay network of claim 15 wherein the encapsulation header further comprises a first system ID of the first BEB, a first system IP address of the first BEB, a second system ID of the second BEB and a second system IP address of the second BEB.
